(19) United States
(12) Patent Application Publication
(10) Pub. No.: US 2013/0121658 A1
(43) Pub. Date: May 16, 2013

(54) Remote Device for Monitoring Probationers.

(71) Applicants: Quyen Kiet, Anaheim, CA (US); Barry Goldstein, Santa Ana, CA (US)

(72) Inventors: Quyen Kiet, Anaheim, CA (US); Barry Goldstein, Santa Ana, CA (US)

(73) Assignee: GOLD POST TECHNOLOGIES, Las Vegas, NV (US)

(21) Appl. No.: 13/465,720

(22) Filed: May 7, 2012

Related U.S. Application Data
(60) Provisional application No. 61/559,377, filed on Nov. 14, 2011.

(51) Int. Cl. H04N 5/77

(52) U.S. Cl. 386/224; 386/E05.069

(57) ABSTRACT

An apparatus and method that allow a probationer to check in remotely to a probation officer is provided. The probationer is provide an device that allows him to check in periodically with the probation officer by recording a video and transmitting the video to a remote server accessible by the probation officer. The device will also transmit location information along with the video to the remote server. The device can also be used for a live chat between the probationer and the probation officer.

### RELATED APPLICATION

This application is a non-provisional of the U.S. Provisional Application for Activated Remote Device, U.S. Provisional Pat. App. No. 61/559,377, filed on Nov. 14, 2011, the specification of which is included in its entirety by this reference.

### BACKGROUND OF THE INVENTION

1. Field of the Invention

The present invention generally relates to intelligent handheld device, and more specifically, relates to an intelligent handheld device that provides video and audio recording capabilities and communicates with a remote server.

2. Description of the Related Art

After a suspect is prosecuted, convicted and sentenced, he is often incarcerated for a portion of the sentence with the balance of the sentence to be served under post-release supervision (or “probation”) or alternative, is sentenced to probation. Usually, the probationer must register with a local authority (or probation office) and he is assigned a probation officer with whom he must check in periodically. A probation officer may be in charge of few dozen or more of probationers and he must make time to monitor and track each probationer. The probationer must physically report with the probation officer every month (sometimes in office, other times in the field, such as the probationer's home or place of work). Most of time, these reporting meetings are routine and no issues result from these meetings.

Even if these meetings are routine and without any important issue to be resolved, the probationers still need to report every month. This physical reporting may be difficult for probationers who have a job. The probationer must take time off from work to visit with the probation officer for a short appointment. The probation officer, on the other hand, must make himself available to meet with the probationers under his supervision. If the probation officer has 60 probationers reporting to him, the probation office must be in his office and meet at least 2 probationers every day of the month. The local government must make offices available for many probation officers who work for the local government for them to meet with these probationers.

In this setting, a lot of time is wasted by the probationers traveling to and from the probation officer, and the probation officers are wasting a lot of energy on these routine reporting instead of tracking on the field those probationers who require more attention. For the local government, resources are wasted by maintaining offices for meetings that can be eliminated.

Therefore, there is a need for a device that enables probation officers to monitor probationers remotely and it is to this system the present invention is primarily directed to.

### SUMMARY OF THE INVENTION

In one embodiment, the present invention provides a system for an apparatus, for enabling a probationer to report remotely to a probation officer. The apparatus comprises a video camera for recording a video file by the probationer, a data communication controller for transmitting the video file to a remote server and for receiving a questionnaire from the remote server; a display device for displaying the questionnaire to the probationer and for displaying a reminder about a reporting time. The data communication controller transmits and receives via a wireless communication network.

In another embodiment, there is also provided a method for a probationer to remotely report to a probation officer. The method comprises the steps of displaying, on a display screen of a device, a first reminder to the probationer, receiving, in response to the probationer agreeing to check in, at a device, a questionnaire from a remote server; providing answers to the questionnaire, recording, if the answers confirm the identity of the probationer, a video using a video camera on the device, and transmitting the video to the remote server.

The present system and methods are therefore advantageous as they enable probationers to check in remotely and probation officers to check on the probationers at their own schedule. Other advantages and features of the present invention will become apparent after review of the hereinafter set forth Brief Description of the Drawings, Detailed Description of the Invention, and the Claims.

### BRIEF DESCRIPTION OF THE DRAWINGS

Features and advantages of embodiments of the invention will become apparent as the following detailed description proceeds, and upon reference to the drawings, where like numerals depict like elements, and in which:

FIG. 1 depicts a system architecture of a system for monitoring a probationer according to the invention;

FIG. 2 is a block diagram for a remote device;

FIG. 3 illustrates a method for a probationer to make a reporting;

FIG. 4 illustrates a process for a remote device to handle a request for a live chat; and

FIG. 5 is a flowchart that depicts the interaction between the remote device and a blue tooth device.

### DETAIL DESCRIPTION OF THE INVENTION

In the following description, the term “exemplary” is meant only as an example, and does not indicate any preference for the embodiment or elements described. Further, like numerals refer to like elements throughout the several views, and the articles “a” and “the” include plural references, unless otherwise specified in the description. The terms “parole officer” and “probation officer” are used interchangeably, so are “parolee” and “probationer.” The “reporting” and “checking in” are also used interchangeably.

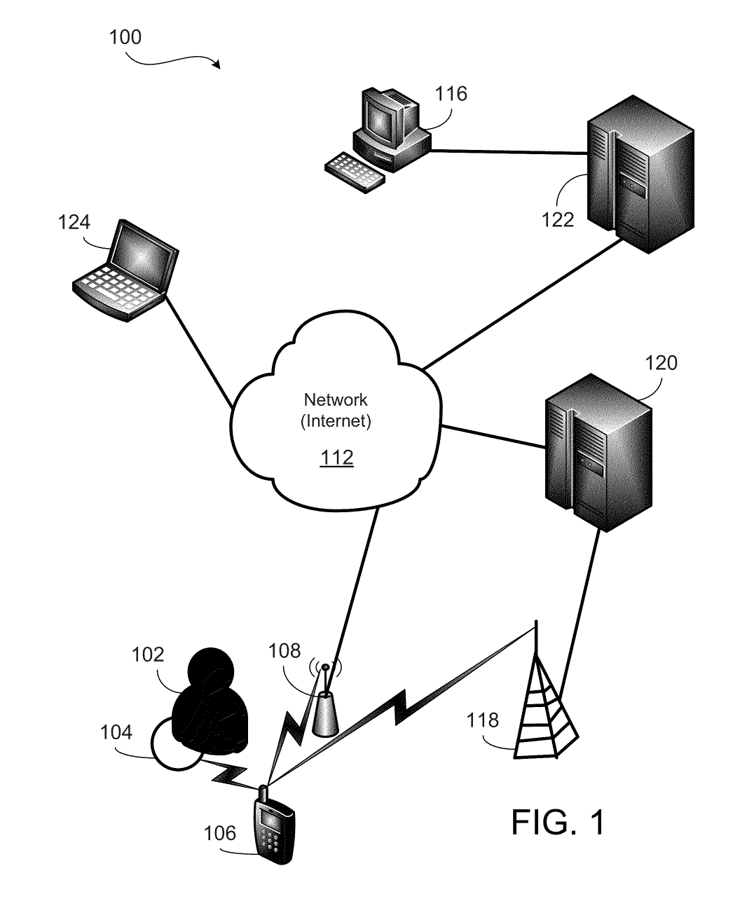

In an overview, the present invention provides a remote device that enables monitoring and tracking of a probationer. The probationer can “check” in on the remote device by recording a video and audio file on the remote device and the remote device then transmits the recorded video and audio file via wireless telecommunications network to a remote server where the audio and audio file can be viewed and analyzed by a probation officer. FIG. 1 illustrates architecture 100 of a system for monitoring a probationer according to the invention. A probationer 102 may be fitted with a blue tooth enabled bracelet 104 that is attached to his body at all time. This bracelet 104 communicates continuously with a remote device 106. The remote device 106 communicates with a cell tower 118, which is connected to a base station (not shown). The base station is connected to a mobile switching center (MSC) 120. The mobile switching center 120 is connected to a data communication network (the Internet) 112. A remote server 122 that collects information from the remote device 106 is also connected to the Internet 112. The information collected can be accessed through a terminal 116 by a probation officer. Optionally, the probation office can also access the information using a laptop computer 124 anywhere through the Internet 112.

The bracelet 104 is or similar to an ankle monitor, but equipped with blue tooth capability. The bracelet 104 communicates continuously with the remote device 102 through blue tooth protocols or other available short range communication protocols. If the communication between the bracelet 104 and the remote device 106 is interrupted, the remote device 106 will make a record and send a notification to the remote server 114.

The remote device 106 is an electronic handheld device, preferably similar in size to a smart phone. The remote device 106 is capable of communicating with the wireless telecommunication network and optionally with a Wi-Fi receiver located inside the probationer's home and connected to the Internet 112. The remote device 106 is also capable of also communicating with a blue tooth device. The remote device 106 is equipped with a video camera and a magnetic inductive charger. The remote device 106 should have a military grade case and be water resistant.

For probationers who are issued a bracelet 104, the remote device 106 continuously communicates with the bracelet 104. If the communication between the bracelet 104 and the remote device 106 is interrupted, the remote device 106 records the information regarding the interruption and transmits the information to the remote server 122.

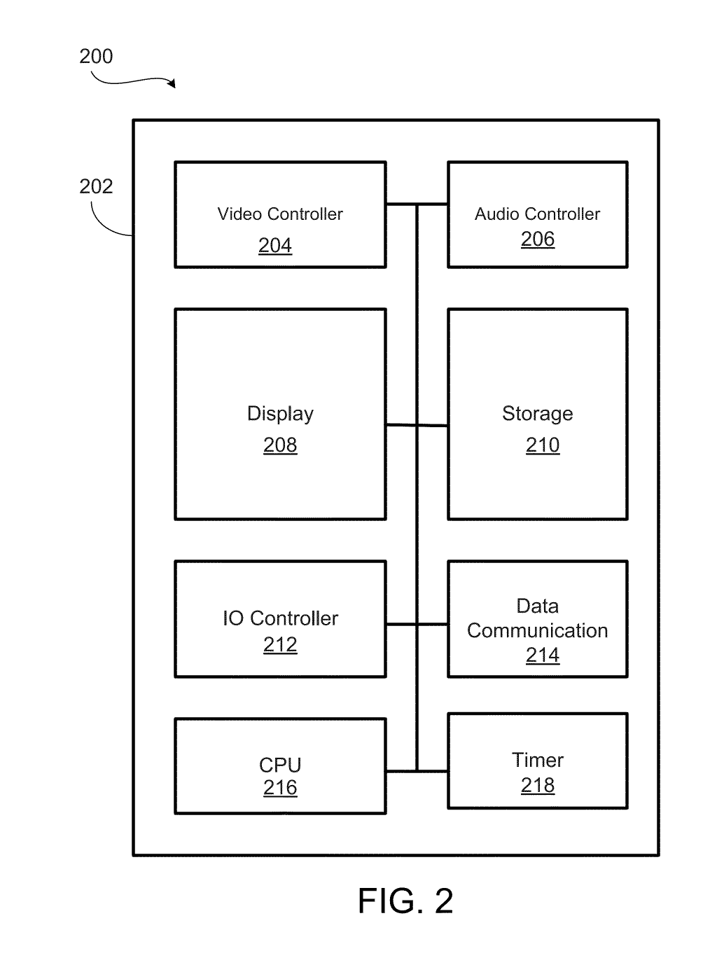

FIG. 2 is a block diagram 200 for a remote device 106. The remote device 106 has a video controller 204 for controlling a video camera (not shown), an audio controller 206 for controlling a speaker and a microphone (not shown), a display screen 208, an input/output (IO) controller 212 for controlling user interface, a data communication controller 214 for transmitting and receiving data wirelessly, a timer 218, a central processing unit (CPU) 216, and a storage unit 210. The video controller 204 controls the video camera and enables the user to record video or take photo. The audio controller 206 allows the user to record audio messages or listen to audio messages. The display screen 208 displays text messages and/or video. The IO controller 212 controls the operation of the display screen 208 and a keypad (not shown). The data communication controller 214 enables the remote device 106 to send and receive data wirelessly to and from a remote server and also to communicate with a blue tooth device. The timer 218 is used for scheduling user events, such as the probationer reporting or checking in with a probation officer. The storage unit 210 is used for storing instructions and audio/video files. The CPU 216 controls the operation of the remote device 106 by executing instructions stored in the storage unit 210. The CPU 216 can coordinate operations needed to set up a live chat between the probationer 102 and the probation officer located remotely. The remote device 106 may also be equipped with a GPS module (not shown) that tracks the current location of the remote device 106.

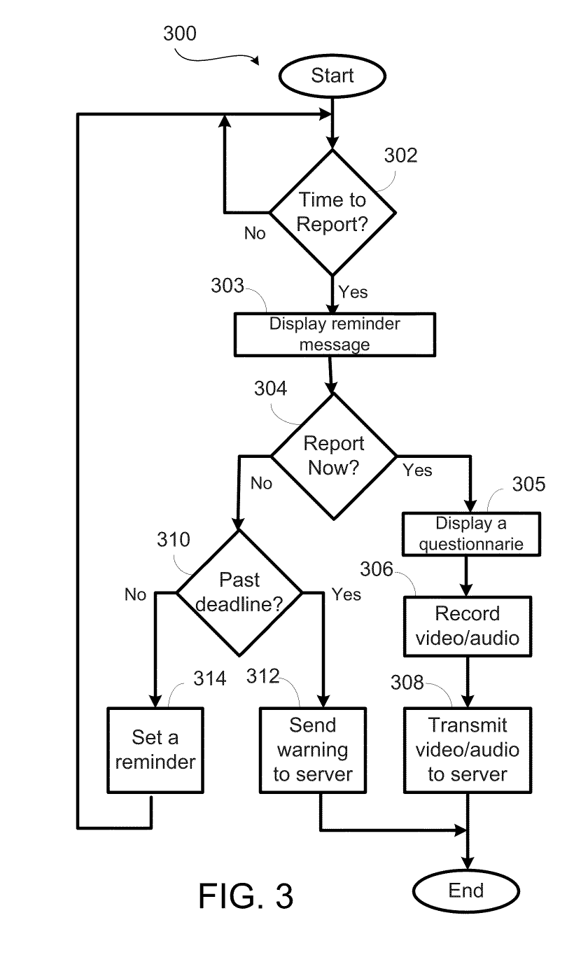

The remote device 106 allows a probationer to report to his probation officer remotely and not in real time. FIG. 3 illustrates a method 300 for a probationer to make a reporting. The timer 218 in the remote device 106 allows the probationer to set up a periodical reminder to check in. The timer 218 may also be set remotely by the probation officer through a command. Instead of the timer 218, the remote device 106 may use a calendar for setting a reminder for reporting. The remote device 106 continuously checks whether it is the time for reporting, step 302. If the timer 218 indicates that it is the time to check in, the remote device 106 will display a message on the display screen 208 reminding the probationer that is the time to check in, step 303, and the probationer 102 is given the option to do it now or later, step 304. If the probationer 102 chooses to report immediately, first the remote device 104 will display a questionnaire for the probationer to answer, step 305. This questionnaire is received from the remote server 122 and can be modified by the probation officer. The questionnaire serves as a way to authenticate the user of the remote device 104 and this prevents from having someone else to report in place of the probationer 102. After the questionnaire is answered, the answers sent back to the remote server 122 for confirmation. If the identity of the user cannot be confirmed, this fact will be recorded and the probation officer notified. If the answer confirms the identity of the user, the remote device 106 will activate video and audio and record audio and video, step 306. The probationer 102 will then look into the camera and report his current status. The remote device 106 will record video and audio and save the recording into a video file. The remote device 106 will transmit the video file to the remote server 122, step 308. The recording can be done when the remote device 106 is not connected to the network and the transmission of the video file can be done at a later time when the remote device 106 is in communication with a wireless network. The remote device 106 can also schedule the transmission of the video file for later when the network traffic is less.

If the probationer 102 decides not to report immediately after the reminder message is displayed, the remote device 106 will check if the deadline for reporting has passed, step 310. If the deadline has passed, the remote device 106 will send a warning message to the remote server 122, informing the remote server 122 that the probationer 102 did not report on time as the probationer 102 is supposed to do. If the deadline for reporting has not passed, the remote device 106 will set a reminder, step 314, and continues to check whether it is time for reporting.

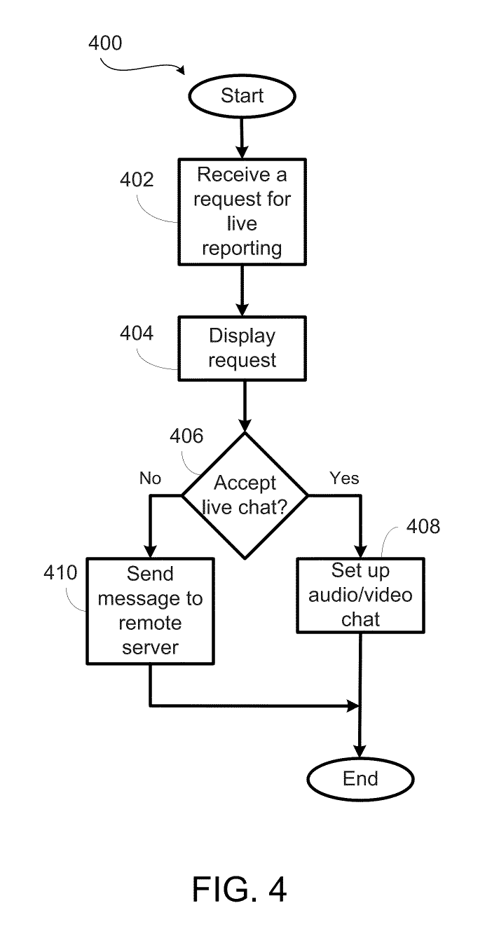

After the video file arrives at the remote server 122, the video file will be available for the probation officer to see. If the probation officer detects something of concern, the probation officer can send a request for a live chat with the probationer. FIG. 4 illustrates a process 400 for the remote device 106 to handle a request for a live chat. After a request for live chat is received by the remote device 106, step 402, the remote device displays the request on the display device 208, step 404. If the probationer 102 is available, the probationer 102 accepts the live chat request, step 406, and the remote device 106 will set up audio/video chat, step 408. If the probationer 102 is not available for the live chat, the remote device 106 will send a message to the remote server 122, step 410, and the probation officer may then take an appropriate response.

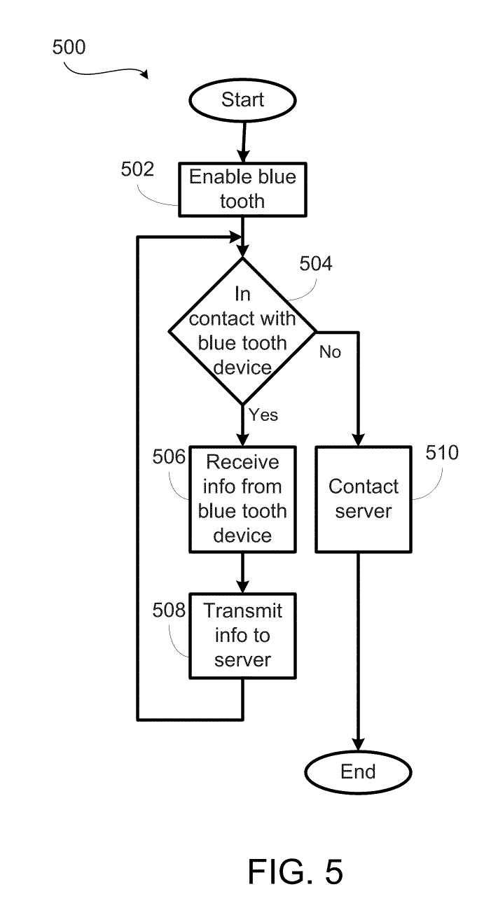

FIG. 5 is a flowchart 500 that depicts the interaction between the remote device 106 and a blue tooth device 104. The blue tooth device 104 maybe a ankle monitor provided by a law enforcement agency or a monitoring agency and the blue tooth device 104 is matched to the remote device 106 provided to the probationer 102. After the blue tooth device 104 is matched to the remote device 106, the blue tooth device 104 is enabled, step 502. After the blue tooth device 104 is enabled, the remote device 106 continuously checks whether it is receiving signal from the blue tooth device 104, step 504. If the remote device 104 is no longer receiving signals from the blue tooth device for an extended period of time, the remote device 104 will send an alert message to the remote server 122, step 510. This may be a scenario that the probationer 102 has wandered away from the remote device 106. The blue tooth device 104 may be an intelligent device that can collect certain information about the probationer, such as the GPS location information or any tampering attempt. The blue tooth device 104 should be weather resistant, specifically water proof, so it can be worn by the probationer at all time, including when taking a shower. The information collected by the blue tooth device 104 is transmitted periodically to the remote device 104, step 506, which will transmit to the remote server 122, step 508.

When in use, the remote device 106 of the present invention enables a probationer to report to his parole officer at his convenience without taking time off from his work and without traveling distance to meet with the parole officer. For instance, a convict may be granted probation after serving time in a regular prison and one condition for the probation is for the convict to report regularly to a probation officer. For convicts of certain crimes, a blue tooth device 104 (ankle monitor or alike) maybe issued and physically attached to him. Besides the blue tooth device 104, the probationer 102 will be issued a remote device 106.

After the release from jail, the probationer may live a normal life with few exceptions. The probationer 102 may live at home and may find a job, and he must report to his probation officer periodically. If the probationer is to report to his assigned probation officer once a month, the remote device 106 can be set to have a reminder to remind him about checking in with the probation officer. On the day for reporting, the remote device 106 will display an alert on the display screen 208. If the probationer 102 is busy when the alert is displayed, the probationer 102 may set a reminder for a later time. At the set later time, the remote device 106 will display another alert to remind the probationer about checking in.

If the probationer 102 is ready to report or check in, the probationer 102 can then use the remote device 104 to record a short video. The video recording may consists the probationer providing his recent information, such as his current address, whether employed or not, and any other information that may be required by the probation officer. The video is stored on the remote device 104 and the remote device 104 will transmit the video file along with other pertinent information, such as time and location of recording, to a remote server 122. The remote server 122 will then make the video available to the probation officer. If the probationer 102 ignores the alert and the time for reporting has passed, the remote device 104 will send a warning to the remote server 122 and the probation officer can then take action.

The transmission of the video file or any alert or warning to the remote server 122 is done through wireless transmission and it can also be done through Wi-Fi connections. When the video file is transferred to the remote server via the wireless communications network, the transmission of the video file is through a data channel and there is no need for a voice channel. The transmission of the video file is done automatically by the remote device without knowledge by the probationer. The transmission can be done in real time after the video is recorded or in batch mode, i.e., scheduled for a time when there is less network traffic.

The method of the present invention can be performed by a program resident in a computer readable medium, where the program directs a computer device, such as a remote device of the present invention, having a computer platform to perform the steps of the method. The computer readable medium can be the memory of the server.

In the context of FIG. 2, the remote device 106 may have different components different from those illustrated in FIG. 2 for multiple components may be combined in a single component and the functions executed by one component in FIG. 2 may be executed by two or more components. In the context of FIGS. 3-5, the steps illustrated do not require or imply any particular order of actions. The actions may be executed in sequence or in parallel.

While the invention has been particularly shown and described with reference to a preferred embodiment thereof, it will be understood by those skilled in the art that various changes in form and detail may be made without departing from the spirit and scope of the present invention as set forth in the following claims. Furthermore, although elements of the invention may be described or claimed in the singular, the plural is contemplated unless limitation to the singular is explicitly stated.

What is claimed is:

1. An apparatus, for enabling a probationer to report remotely to a probation officer, comprising:
a video camera for recording a video file by the probationer;
a data communication controller for transmitting, via a wireless communication network, the video file to a remote server and for receiving, via the wireless communication network, a questionnaire from the remote server; and
a display device for displaying the questionnaire to the probationer and for displaying a reminder about a reporting time.

2. The apparatus of claim 1 further comprising a GPS module for tracking a current location of the apparatus.

3. The apparatus of claim 2, wherein the video file is sent to the remote server with location information derived from the GPS module.

4. The apparatus of claim 1, further comprising a time for tracking the reporting time.

5. The apparatus of claim 0, wherein the data communication controller transmits the video file in a batch mode.

6. The apparatus of claim 0, wherein the data communication controller receives a live chat request from the remote server.

7. The apparatus of claim 6, wherein the CPU, in response to the live chat request received, sets up a live chat between the probationer and the probation officer.

8. The apparatus of claim 1, wherein the video camera records the video file if answers to the questionnaire confirm the identity of the probationer.

9. A method, for a probationer to remotely report to a probation officer, comprising the steps of:
displaying, on a display screen of a device, a first reminder to the probationer;
receiving, in response to the probationer agreeing to check in, at a device, a questionnaire from a remote server;
providing answers to the questionnaire;
recording, if the answers confirm the identity of the probationer, a video using a video camera on the device; and
transmitting the video to the remote server.

10. The method of claim 9, further comprising the step of setting a second reminder to display on the display screen at a later time;

11. The method of claim 9, further comprising the steps of:
checking if a reporting deadline has passed; and
sending, if the reporting deadline has passed, a warning message to the remote server.

12. The method of claim 9, further comprising the step of scheduling transmission of the video to the remote server to a later time.

13. The method of claim 9, further comprising the steps of:
receiving, at the device, a live chat request from the remote server; and
setting, using the device, up a live chat between the probationer and the probation officer.

14. The method of claim 13, further comprising the step of sending, if the probationer does not answer to the live chat request, a message to the remote server.

15. The method of claim 9, further comprising the step of transmitting a location information along with the video to the remote server.
